(19) United States
(12) Patent Application Publication
(10) Pub. No.: US 2023/0092209 A1
(43) Pub. Date: Mar. 23, 2023

(54) AEROSOL-GENERATING DEVICE WITH COLD PLASMA CLEANING

(71) Applicant: Philip Morris Products S.A., Neuchatel (CH)

(72) Inventors: Ricardo CALI, Mannheim (DE); Irene TAURINO, Neuchatel (CH); Toney Moses RAJAN, Mannheim (DE)

(73) Assignee: Philip Morris Products S.A., Neuchatel (CH)

(21) Appl. No.: 17/904,920

(22) PCT Filed: Feb. 25, 2021
(86) PCT No.: PCT/EP2021/054696

§ 371 Date: Aug. 24, 2022

(30) Foreign Application Priority Data
Feb. 28, 2020 (EP) 20160223.2

(51) Int. Cl. A24F 40/85; A24F 40/46

(52) U.S. Cl. CPC A24F 40/85; A24F 40/46

(57) ABSTRACT

An aerosol-generating device is provided, including: a heating element to heat an aerosol-generating article to generate an aerosol; and a cleaning apparatus arranged to cooperate with the heating element and to clean a surface of the heating element, in which the cleaning unit includes at least one piezoelectric element, and in which the piezoelectric element is configured to generate cold plasma to clean the surface of the heating element. A method for cleaning a heating element of an aerosol-generating device, and a method for manufacturing an aerosol-generating device, are also provided.

The present disclosure relates to an aerosol-generating device for use in the consumption of a smoking article. The aerosol-generating device comprises a cleaning unit for a heating element. The present disclosure further relates to a method for cleaning a heating element of an aerosol-generating device and a method for manufacturing such aerosol-generating device.

Smoking articles in which an aerosol-forming substrate, such as a tobacco containing substrate, is heated rather than combusted are known in the art. The aim of such heated smoking articles is to reduce known harmful smoke constituents produced by the combustion and pyrolytic degradation of tobacco in conventional cigarettes. Typically in such heated smoking articles, an aerosol is generated by the transfer of heat from a heat source to a physically separate aerosol-forming substrate or material, which may be located within, around or downstream of the heat source. During smoking, volatile compounds are released from the aerosol-forming substrate by heat transfer from the heat source and entrained in air drawn through the smoking article. As the released compounds cool, they condense to form an aerosol that is inhaled by the consumer.

Typically, smoking articles for use with aerosol-generating devices comprise an aerosol-forming substrate that is assembled, often with other elements or components, in the form of a stick. Typically, such a stick is configured in shape and size to be inserted into an aerosol-generating device that comprises a heating element for heating the aerosol-forming substrate.

In an aerosol-generating device, the generation of the aerosol takes place when the aerosol-forming substrate is exposed to the active heating element. The aerosol-forming substrate is composed of complex organic compounds. When this aerosol-forming substrate generates the aerosol on heating, non-volatile organic residues from the aerosol-forming substrate stay and accumulate on the heating element surface. These organic residues accumulated on the heating element may act as a heat resistive layer over time. Formation of this resistive layer affects the aerosol generation such that it increases the energy requirement and consumption.

Presently, for the cleaning of the heating element, methods such as pyrolysis or other procedures, for example, ultrasonic cleaning or manually cleaning like brushing are being utilized. Pyrolysis is for example described in EP2797444 (A1). This document discloses a method of using an aerosol-generating device that comprises the steps of bringing a heating element of the aerosol-generating device into contact with an aerosol-forming substrate, raising the temperature of the heating element to a first temperature to heat the aerosol-forming substrate sufficiently to form an aerosol, removing the heating element from contact with the aerosol-forming substrate and heating the heating element to a second temperature, higher than the first temperature, to thermally liberate organic materials adhered to or deposited on the heating element. An embodiment of an aerosol-generating device comprises a heating element coupled to a controller for heating the heating element to the first temperature and to the second temperature.

Some of the prior art cleaning methods consume relatively large amounts of electric energy such that, for example, a battery of the aerosol-generating device is drained more quickly. Additionally, in some cases, if the battery is worn out, it would also require the aerosol-generating device to be sent to an authorized service center. These methods make the whole cleaning process costly and time-consuming. On the contrary, some of the users of the aerosol-generating devices clean the device heating element independently using unsuitable brushes or by using unauthorized chemical reagents. This action can lead to damaging the heating element rendering it unusable.

As a summary, an effective removal of organic residues on a heating element of an aerosol generator using the existing method requires relatively large amounts of electric energy and is time-consuming.

Hence, there may be a need to provide an alternative aerosol-generating device with a cleaning unit for its heating element.

The object of the present disclosure is solved by the subject-matters of the independent claims, wherein further embodiments are incorporated in the dependent claims. It should be noted that the aspects of the disclosure described in the following apply to the aerosol-generating device, the method for cleaning a heating element of an aerosol-generating device and the method for manufacturing an aerosol-generating device.

According to an aspect of the present disclosure, there is provided an aerosol-generating device. The aerosol-generating device comprises a heating element and a cleaning unit.

The heating element is configured for heating an aerosol-generating article to generate an aerosol.

The cleaning unit is arranged to cooperate with the heating element for cleaning a surface of the heating element. The cleaning unit comprises at least one piezoelectric element.

The piezoelectric element is configured to generate cold plasma for cleaning the surface of the heating element.

The aerosol-generating device according to the present disclosure can be used as an aerosol-generating device with an integrated cleaning arrangement for cleaning accumulated organic residues on the heating element using cold plasma. The heating element and the cleaning unit can be arranged within the aerosol-generating device. The aerosol-generating device can use cold plasma to remove organic residue using a piezoelectric cleaning arrangement. In other words, the disclosure can refer to a plasma cleaner for cleaning a heating element used in an aerosol-generating device. The piezoelectric element can be used to generate cold plasma for cleaning organic residues from the heating element. During cleaning, there is no consumable or aerosol generating article in the aerosol-generating device.

In contrast to conventional aerosol-generating device with cleaning units, the present aerosol-generating device is easier to handle. Due to the piezoelectric element and the use of cold plasma, the cleaning can be done at ambient conditions. Due to the arrangement of the piezoelectric element, the cleaning of the heating element may be done inside the aerosol-generating device. The device could be designed such that there is no need for disassembling the aerosol-generating device and battery life may be extended. The aerosol-generating device, the cleaning element and the heating element may have small dimensions, which can easily be integrated into existing devices.

The lifetime and the efficiency of the heating element and thereby of the aerosol-generating device may be extended. The aerosol-generating device may consume less energy. Further, the cleaning may consume less time. Furthermore, the aerosol-generating device can be less costly.

The cleaning of the heating element may be better. It may be more effective through a “blast off” effect of ionic wind jets and a breakdown of molecules. The cold plasma may minimize any detrimental effects on the heating element or the user of the aerosol-generating device. The piezoelectric element, as used in the aerosol-generating device, generates no high-frequency radiation or high voltage or direct charge transfer compared to conventional arc-discharge plasma. It operates at low temperature. Thus, it would not have any additional safety factor consideration for its usability or its commercial manufacturing.

An operation of the cleaning unit of the aerosol-generating device can be understood as follows: When subjected to electric voltage, the piezoelectric element of the cleaning unit may react by a generation of mechanical oscillation, preferably high-frequency mechanical oscillation. The mechanical oscillation of dielectric material within the piezoelectric element may create an electric field resulting in ionized or ionization gas in its vicinity. The ionized gas may form cold plasma, in form of ionic wind jets. The cold plasma generated with the piezoelectric direct discharge can remain at 75 degrees Celsius or less, preferably 50 degrees Celsius or less. The generated cold plasma may have a temperature in a range of 17 to 75 degree Celsius or preferably 17 to 50 degree Celsius. The cold plasma can interact with organic residues on the surface of the heating element for cleaning them from the heating element. The cold plasma can break down heavy organic molecule residuals to light residuals and volatilizable organic molecules. The light organic residual chemical species (such as carbon) on the heating element can oxidize to form (carbon) oxides and water vapour. The volatilizable organic molecules can evaporate at room temperature from the heating element surface, leaving it in a clean state. In addition, the light organic residual chemical species can be volatilizable. The same applies for heavy organic molecule residuals.

The wording ‘aerosol-generating device’ relates to a device that interacts with an aerosol-forming substrate to generate an aerosol. The aerosol-forming substrate may be part of an aerosol-generating article, for example part of a smoking article. An aerosol-generating device may comprise one or more components used to supply energy from a power supply to an aerosol-forming substrate to generate an aerosol. The aerosol-generating device and all its components may be portable and mobile. It may have the size of a normal handheld device.

The heating element can be provided in different shapes, sizes and numbers. For example, the heating element can be shaped as a needle, pin, rod, or blade that may be inserted into a smoking article in order to contact the aerosol-forming substrate. The aerosol-generating device may comprise more than one heating element and in the following description, reference to a heating element means one or more heating elements. The aerosol-generating device may also comprise electronic circuitry arranged to control a supply of current to the heating element to control its temperature. The aerosol-generating device may also comprise means for sensing the temperature of the heating element.

The cleaning unit comprises at least one piezoelectric element. The cleaning unit is arranged to cooperate with the heating element for cleaning a surface of the heating element. For example, the piezoelectric element can be installed within the aerosol-generating device. This can be at a charging unit for a power unit of the aerosol-generating device or inside a stick holder (for the aerosol-generating article) or at any other suitable location.

The piezoelectric element can be a piezoelectric transformer. The piezoelectric element can have different geometrical shapes, for example, rectangular, semi-circular, and spiral. The piezoelectric element is configured to generate cold plasma in a vicinity of the surface of the heating element. The cold plasma is configured to interact with the surface of the heating element for cleaning the surface. “In a vicinity” can be understood in that the generated cold plasma touches the surface of the heating element. In particular, the gas stream of ions and free electrons forming the cold plasma contacts the surface of the heating element and the ions and electrons hit the surface of the heating element. The piezoelectric element may therefore be arranged close, adjacent or next to the surface of the heating element. A distance between the piezoelectric element and the surface of the heating element should be as close as possible, for example 2 mm and less, preferably 1 mm and less, and more preferably 0.5 mm and less.

Cold plasma can be understood as a gas of ions and free electrons. Cold plasma or non-thermal plasma is not in thermodynamic equilibrium and can comprise ions (and neutrally charged particles) at a low temperature (75 degrees Celsius or less, preferably 50 degrees Celsius or less, a range of 17 to 75 degree Celsius or 17 to 50 degree Celsius), whereas electrons are hotter.

“Cleaning” can be understood as reducing, removing, liberating and/or eliminating the amount of unwanted species on the surface of the heating element. The unwanted species may be residues generated by the heating of the aerosol-forming substrate. It might be non-volatile organic residues and in particular carbon species that remain and accumulate on the heating element surface.

The piezoelectric element may be configured to generate the cold plasma at atmospheric pressure. The piezoelectric element can be configured to generate the cold plasma in ambient air. As a consequence, the aerosol-generating device is easy to handle. There is no need for handling high pressure systems, high voltage or the like. Additionally, no safety considerations for its usability or its manufacturing are necessary.

The piezoelectric element may be configured to generate the cold plasma at a temperature in a range of 75 degrees Celsius or less, preferably 50 degrees Celsius or less. The piezoelectric element may be configured to generate the cold plasma at a temperature in a range of 17 to 75 degree Celsius. The piezoelectric element may be configured to generate the cold plasma at a temperature in a range of 17 to 50 degree Celsius. In an example, the piezoelectric element is configured to generate the cold plasma at room temperature (e.g. 17 to 25 degree Celsius). Consequently, the aerosol-generating device consumes less energy than a conventional device and is easy to handle. There is no need for providing and handling high temperatures, which makes use and manufacturing safer.

The piezoelectric element may comprise a piezoelectric crystal. The piezoelectric element may be composed of lead zirconate titanate. The piezoelectric element may be composed of either lead zirconate titanate or a mixture of lead zirconate with lead titanate (Pb (ZrxTi1-x) O₃ (PZT)) and barium titanates (BaTiO₃ (BTO)). The piezoelectric element can have a protective ceramic layer. The protective ceramic layer may give the piezoelectric element a minimum shelve life of, for example, three years. These materials are very effective and still good for manufacturing.

The dimensions of the piezoelectric element or the piezoelectric crystal may range from 0.5 millimetres to 0.9 millimetres in thickness. The dimensions of the piezoelectric element or the piezoelectric crystal may range from 0.5 millimetres to 0.9 millimetres in width. The dimensions of the piezoelectric element or the piezoelectric crystal may range from 0.5 to 4 centimetres in length. These dimensions can allow for a comfortable small, light and handheld aerosol-generating device.

The piezoelectric element can have a first end or region and a second end or region opposite to the first end. The piezoelectric element can be, for example, a cuboid with a longitudinal direction. The piezoelectric element can be a parallelepiped or a trapezoid. Each pair of adjacent faces of the piezoelectric element can meets in a right angle. Adjacent faces of the piezoelectric element may also meet in an angle different to 90 degrees. The first end may be opposite to the second end with respect to the longitudinal direction of the cuboid.

The cleaning unit may comprise at least two electrodes and the first end of the piezoelectric element is arranged between these electrodes. The electrode(s) can be made of copper or silver or an alloy or the like. Such implementation of the piezoelectric element and the electrodes is very easy to construct.

The cleaning unit may comprise a plurality of piezoelectric elements and a plurality of electrodes. Respective first ends of the plurality of piezoelectric elements can be arranged between adjacent electrodes in a layered stack arrangement. The electrode(s) can be made of copper or silver or an alloy or the like. Such implementation of several piezoelectric elements and electrodes can provide a more powerful, but still compact, cleaning unit.

The cold plasma may be formed as ionic wind jets when an electrical field strength on the surface of the piezoelectric element is reached. Piezoelectric direct discharge from corners, edges or tips of the piezoelectric element may occur as cold plasma, namely ionic wind jets. The term “ionic wind jet” can be understood as ion wind, ionic wind, coronal wind or electric wind and is an airflow induced by electrostatic forces linked to corona discharge arising at corners, edges or tips subjected to high voltage relative to ground. Net electric charges on conductors, including local charge distributions associated with dipoles, reside entirely on their external surface and tend to concentrate more around sharp corners, edges or tips than on flat surfaces. This means that the electric field generated by charges on corners, edges or tips is much stronger than the field generated by the same charge residing on a large conductive shell. When this electric field strength exceeds what is known as the corona discharge inception voltage gradient, it ionizes the air about the corners, edges or tips, and a small faint purple jet of cold plasma can be seen in the dark on the conductive corners, edges or tips. Ionization of the nearby air molecules may result in generation of ionized air molecules having the same polarity as that of the charged corners, edges or tips. Subsequently, the corners, edges or tips may repel the like-charged ion cloud, and the ion cloud immediately expands due to the repulsion between the ions themselves. This repulsion of ions may create an electric “wind” that emanates from the corners, edges or tips.

The form of the ionic wind jets can be controlled using the different shapes of the piezoelectric element. The second end of the piezoelectric element may have a rectangular shape with at least two corners at the end to generate the cold plasma as direct discharge ionic wind jets in an orthogonal plane relative to a front line connecting the two corners of the piezoelectric element. The piezoelectric element may have a rectangular shape with four corners on an outer edge of the piezoelectric element so that direct discharge of ionic wind jets in an orthogonal manner relative to a front face of the piezoelectric element occurs. Such shape of the piezoelectric element and the ionic wind jets allows for a wide area on the heating element to be cleaned.

The second end of the piezoelectric element can have a protrusion to generate the cold plasma as a point ionic wind jet in the same direction as the protrusion. The cold plasma may be generated as a point ionic wind jet in a substantially orthogonal plane relative to the protrusion of the piezoelectric element. The piezoelectric element may have a sharp ending or tip, which may generate at a single point multiple ionic wind jets in a direction normal to the tip of the piezoelectric element. Such shape of the piezoelectric element and the ionic wind jet allows for a focussed spot on the heating element to be cleaned very intensively.

The aerosol-generating device may comprise a power unit configured to supply power to the heating element and to the cleaning unit. Preferably, this power unit is the only power supply of the aerosol-generating device. In other words, there are not two different power units for the heating element and the cleaning unit. For example, the power unit may be or comprise a (rechargeable) battery. This avoids the need for a second power supply, which would add weight, volume and cost.

There are many ways to activate the cleaning. The aerosol-generating device may comprise a user-operable button to activate the cleaning unit. To achieve the cleaning, pressing the button on the aerosol-generating device would result in the activation of the cleaning function of the cleaning unit. As a result, a user may decide that the heating element needs to be cleaned and actuate the cleaning.

Alternatively or additionally to the button, the aerosol-generating device may comprise a control unit. The control unit can be a processor.

The control unit may automatically activate the cleaning unit at predetermined intervals or events. This cleaning function can be automatically initiated after, for example, each experience, which would ensure the heating element remains fully efficient and hygienic before the next experience. The aerosol-generating device may comprise means for recording a number of smoking articles consumed by a user and the control unit may then automatically start a cleaning after a predetermined number of smoking articles have been consumed. The predetermined number of consumed smoking articles may be for example two, five or 10. The means for recording a number of smoking articles consumed may be a processor counting, for example, a number of heating events.

The aerosol-generating device may comprise means for detecting when the heating element is removed from contact with the aerosol-forming substrate, for example, when a smoking article is removed from the device. When such an event is detected, the control unit may be start a cleaning. The means for detecting when the aerosol-forming substrate is removed may be, for example, an induction coil, an aerosol-forming substrate sensor, a physical switch, which may be pressed by an aerosol-forming substrate, and/or the like.

The aerosol-generating device may comprise means for detecting when a battery of the aerosol-generating device is charged. When such an event is detected, the control unit may be start a cleaning. The means for detecting when a battery of the aerosol-generating device is charged may be, for example, an electronic circuit.

The control unit may be combined with one, several or all of the above explained means. The person skilled in the art will readily appreciate how to implement these means.

There are many examples to arrange the components of the aerosol-generating device.

In one case, the aerosol-generating device may comprise a charging unit for receiving charging power for the power unit of the aerosol-generating device. The charging unit can have a stick charging compartment with a top or free end comprising an opening for inserting a stick holder holding an aerosol-generating article or stick. The charging unit can have a bottom end opposite to the top end. The bottom end may be physically connected to the aerosol-generating device. The cleaning unit can be arranged inside the charging unit. The cleaning unit can be arranged at the bottom end of the charging unit. This arrangement can allow the aerosol-generating device to be very small and compact. Once the stick holder is inserted into the stick charging compartment of the charging unit, the cleaning unit including the piezoelectric element arranged at the bottom end of the charging unit comes in contact with the heating unit. When the stick holder is inserted into the stick charging compartment, a cavity door of the aerosol-generating device can be closed by moving a hinge opening toward the charging compartment. On closing the cavity door, the aerosol-generating device can be configured to automatically trigger the control unit for activating the cleaning unit.

In another case of arranging the components of the aerosol-generating device, the cleaning unit including the piezoelectric element can be arranged inside the stick holder holding an aerosol-generating article. In contrast to the above embodiment, there may be no charging unit. This arrangement allows for a very easy and elegant handling of the aerosol-generating device.

The aerosol-generating device may comprise a retracting cleaning arrangement and the piezoelectric element may be a retractable piezoelectric element. The retracting cleaning arrangement may comprise a micro-motor for moving the retractable piezoelectric element relative to the heating element. The micro-motor may move the heating element from a retracted position more remote from the heating element to an extended position closer to the heating element. The micro-motor may be activated by a retraction button. The micro-motor may move the heating element by means of a spindle. When the cleaning process is complete, the micro-motor may lower the retracting cleaning arrangement again to the retracted position.

According to another aspect of the present disclosure, there is provided a method for cleaning a heating element of an aerosol-generating device. The method for cleaning a heating element of an aerosol-generating device comprises the step of
generating cold plasma by means of a piezoelectric element, wherein the cold plasma cleans a surface of the heating element.

In contrast to conventional methods for cleaning a heating element of an aerosol-generating device, the present method is easier to handle. The cleaning of the heating element may be done inside the aerosol-generating device. Disassembly of the aerosol-generating device may be avoided. The efficiency of the method for cleaning a heating element of an aerosol-generating device may be improved. The method for cleaning a heating element of an aerosol-generating device may consume less energy and less time. Furthermore, the cleaning method can be less costly. The cleaning result may be better.

Cleaning may be understood as an interaction with debris and a removal of the debris from a surface of the heating element.

An exemplary operation of the method for cleaning a heating element may be as follows: The step of generating cold plasma comprises the steps of applying electric voltage to a first region of the piezoelectric element, and thereby forming the cold plasma for cleaning the surface of the heating element. The electric voltage may have a peak to peak AC voltage in a range of 5-15 Vpp. The AC potential may be applied to the at least one or more electrode(s). Such voltage levels can be rather modest and therefore safe to use.

The electric voltage may cause a mechanical oscillation of the piezoelectric element. The oscillation can be understood as deformations of microscopic dimensions, for example in a sub-micrometer range. The mechanical oscillation of the piezoelectric element may have a frequency in a range of 10 kHz and 500 kHz. The mechanical oscillation of the piezoelectric element may depend on the dimensions of the piezoelectric element.

The mechanical oscillation may propagate along the piezoelectric element, for example from the first region of the piezoelectric element to a second region of the piezoelectric element opposite to the first region. The mechanical oscillation may be generated from the first region or end of the piezoelectric element and may propagate to the opposite, second region or end of the piezoelectric element along the longitudinal direction of the piezoelectric element. At the second region, the mechanical oscillation may create an electric field. The second region of the piezoelectric element may then be subjected to an electric potential, e.g. from 3 kV to 20 kV. An outer edge of the second region of the piezoelectric element can be provided in a metallized form to facilitate an application of the high electric potential.

The electric field may results in ionization gas. The ionization gas may form the cold plasma for cleaning the heating element. In other words, the cold plasma may be formed as ionic wind jets when a strength of the electrical field on the surface of the piezoelectric element exceeds a required threshold ionization field strength. When this threshold field applied to the piezoelectric element is exceeded, which can happen very quickly (for example, within microseconds), these charges may form a piezoelectric direct discharge from corners and/or edges of the piezoelectric element as cold plasma, namely ionic wind jets. The ionization gas as well as the cold plasma are safe to use.

For cleaning the surface of the heating element, the cold plasma may break down organic molecules of organic residues on the surface of the heating element into lighter and/or volatilizable organic molecules. The lighter organic residuals can oxidize to form (carbon) oxides and water vapour. The (carbon) oxides, the water vapour and/or the volatilizable organic molecules can evaporate at room temperature from the heating element. This way of cleaning can be very effective and efficient.

The cold plasma may be generated at atmospheric pressure. The ability to generate cold plasma at atmospheric pressure makes the aerosol-generating device easy to handle and avoids any safety considerations for its usability or its manufacturing.

The cold plasma may be generated at a temperature in a range of 75 degrees Celsius or less, preferably 50 degrees Celsius or less. The cold plasma may be generated at a temperature in a range of 17 to 75 degree Celsius. The cold plasma may be generated at room temperature (e.g. 17 to 25 degree Celsius). The use of such low temperature allow a low energy consumption and an easy handling without any need for safety considerations.

The method for cleaning a heating element of an aerosol-generating device may comprise the step of actuating a user-operable button on the aerosol-generating device to activate the cleaning unit. In this way, the cleaning step may be actuated manually by a user. For example, a user may decide that the heating element needs to be cleaned and actuate the cleaning. Actuation may be affected by pressing the button on the aerosol-generating device. Preferably, the cleaning is terminated automatically after a predetermined or pre-programmed period of time.

The method for cleaning a heating element of an aerosol-generating device may comprise the step of automatically activating the cleaning unit at predetermined intervals by means of a control unit. The control unit can be a processor. This cleaning function ensures that the heating element remains fully efficient and hygienic.

According to another aspect of the present disclosure, there is provided a method for manufacturing an aerosol-generating device. The method for manufacturing an aerosol-generating device comprises the following steps, not necessarily in this order:
providing a heating element for heating an aerosol-generating article to generate an aerosol,
providing a cleaning unit comprising at least one piezoelectric element, the piezoelectric element being configured to generate cold plasma for cleaning the surface of the heating element, and
arranging the cleaning unit to allow a cooperation with the heating element for cleaning the surface of the heating element.

The present method for manufacturing an aerosol-generating device is easy. The manufacturing can be made fast, without much expenses and/or without being prone to defects.

The present manufacturing method allows producing an aerosol-generating device with an integrated cleaning unit, which is easier to handle. The cleaning of the heating element may be done inside the aerosol-generating device. The cleaning can be done at ambient conditions. There may be no need for disassembling the aerosol-generating device.

The aerosol-generating device may consume less energy. Further, the cleaning may consume less time. The cleaning of the heating element may be better.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may comprise one or more components used to supply energy from a power supply to an aerosol-forming substrate to generate an aerosol.

An aerosol-generating device may be described as a heated aerosol-generating device, which is an aerosol-generating device comprising a heater or heating element. The heater is preferably used to heat an aerosol-forming substrate of an aerosol-generating article to generate an aerosol.

An aerosol-generating device may be an electrically heated aerosol-generating device, which is an aerosol-generating device comprising a heater that is operated by electrical power to heat an aerosol-forming substrate of an aerosol-generating article to generate an aerosol. An aerosol-generating device may be a gas-heated aerosol-generating device. An aerosol-generating device may be a smoking device that interacts with an aerosol-forming substrate of an aerosol-generating article to generate an aerosol that is directly inhalable into a user's lungs through the user's mouth.

As used herein, the term ‘aerosol-forming substrate’ relates to a substrate capable of releasing volatile compounds that can form an aerosol. Such volatile compounds may be released by heating the aerosol-forming substrate. An aerosol-forming substrate may be adsorbed, coated, impregnated or otherwise loaded onto a carrier or support. An aerosol-forming substrate may conveniently be part of an aerosol-generating article or smoking article.

An aerosol-forming substrate may be solid or liquid and may comprise nicotine. An aerosol-forming substrate may comprise tobacco, for example may comprise a tobacco-containing material containing volatile tobacco flavour compounds, which are released from the aerosol-forming substrate upon heating. In preferred embodiments an aerosol-forming substrate may comprise homogenised tobacco material, for example cast leaf tobacco.

As used herein, the terms ‘aerosol-generating article’ and ‘smoking article’ refer to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

Optionally, an aerosol-generating article is a heated aerosol-generating article, which is an aerosol-generating article comprising an aerosol-forming substrate that is intended to be heated rather than combusted in order to release volatile compounds that can form an aerosol. The aerosol formed by heating the aerosol-forming substrate may contain fewer known harmful constituents than would be produced by combustion or pyrolytic degradation of the aerosol-forming substrate. An aerosol-generating article may be, or may comprise, a tobacco stick.

The aerosol-forming substrate may be a solid aerosol-forming substrate. Alternatively, the aerosol-forming substrate may comprise both solid and liquid components. The aerosol-forming substrate may comprise a tobacco-containing material containing volatile tobacco flavour compounds, which are released from the substrate upon heating. Alternatively, the aerosol-forming substrate may comprise a non-tobacco material. The aerosol-forming substrate may comprise an aerosol former. Examples of suitable aerosol formers are glycerine and propylene glycol.

If the aerosol-forming substrate is a solid aerosol-forming substrate, the solid aerosol-forming substrate may comprise, for example, one or more of: powder, granules, pellets, shreds, spaghettis, strips or sheets containing one or more of: herb leaf, tobacco leaf, fragments of tobacco ribs, reconstituted tobacco, processed tobacco, homogenised tobacco, extruded tobacco and expanded tobacco. The solid aerosol-forming substrate may be in loose form, or may be provided in a suitable container or cartridge. For example, the aerosol-forming material of the substrate may be contained within a paper or wrap and have the form of a plug. Where an aerosol-forming substrate is in the form of a plug, the entire plug including any wrapping paper is considered to be the aerosol-forming substrate.

Optionally, the solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, spaghettis, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

Optionally, the aerosol-forming substrate is contained in a smoking article, for example a stick-shaped smoking article such as a cigarette. The smoking article is preferably of suitable size and shape to engage with the aerosol-generating device to bring the aerosol-forming substrate into contact with the heating element of the device. For example, the smoking article may have a total length between approximately 30 mm and approximately 100 mm. The smoking article may have an external diameter between approximately 5 mm and approximately 12 mm.

The person skilled in the art will readily appreciate which organic residues can be deposited on the heating element after use of at least one of the above mentioned types of aerosol-forming substrates.

Below, there is provided a non-exhaustive list of non-limiting examples. Any one or more of the features of these examples may be combined with any one or more features of another example, embodiment, or aspect described herein.
A. An aerosol-generating device comprising:
   a heating element configured for heating in use an aerosol-generating article to generate an aerosol, and
   a cleaning unit arranged to cooperate with the heating element for cleaning in use a surface of the heating element,
   wherein the cleaning unit comprises at least one piezoelectric element, and wherein the piezoelectric element is configured to generate cold plasma for cleaning the surface of the heating element.
B. Aerosol-generating device according to example A, wherein the piezoelectric element is configured to generate the cold plasma at atmospheric pressure.
C. Aerosol-generating device according to example A, wherein the piezoelectric element is configured to generate the cold plasma at a temperature in a range of 17 to 75 degree Celsius.
D. Aerosol-generating device according to example A, wherein the piezoelectric element has a first end, wherein the cleaning unit comprises at least two electrodes, and wherein the first end of the piezoelectric element is arranged between these electrodes.
E. Aerosol-generating device according to example A, wherein the piezoelectric element has a second end with a protrusion to generate the cold plasma as a point ionic wind jet in a substantially orthogonal plane relative to the protrusion of the piezoelectric element.
F. Aerosol-generating device according to example A, wherein the piezoelectric element has a second end with a rectangular shape with at least two corners at the end to generate the cold plasma as direct discharge ionic wind jets in an orthogonal plane relative to a front line connecting the two corners of the piezoelectric element.
G. Aerosol-generating device according to example A, further comprising a charging unit for receiving in use charging power for a power unit of the aerosol-generating device, wherein the charging unit has a top end with an opening for inserting an aerosol-generating article and a bottom end opposite to the top end, wherein the cleaning unit is arranged inside the charging unit and at the bottom end of the charging unit.
H. Aerosol-generating device according to example A, further comprising a holding unit for receiving an aerosol-generating article, wherein the piezoelectric element is arranged inside the holding unit.
I. Aerosol-generating device according to example A, wherein the cleaning unit comprises a plurality of piezoelectric elements and a plurality of electrodes, wherein respective ends of the plurality of piezoelectric elements are arranged between adjacent electrodes in a layered stack arrangement.
J. Aerosol-generating device according to example A, further comprising a power unit configured to supply power to the heating element and to the cleaning unit, wherein this power unit is the only power supply of the aerosol-generating device.
K. Aerosol-generating device according to example A, wherein the piezoelectric element is composed of lead zirconate titanate or of a mixture of lead zirconate with lead titanate and barium titanate.
L. Aerosol-generating device according to example A, wherein the piezoelectric element comprises a piezoelectric crystal with dimensions ranging from 0.5 millimetres to 0.9 millimetres in thickness and/or width and/or 0.5 to 4 centimetres in length.
M. A method for cleaning a heating element of an aerosol-generating device, the method comprises the step of:
   generating cold plasma by means of a piezoelectric element, wherein the cold plasma cleans a surface of the heating element.
N. Method for cleaning according to example M, wherein the step of generating cold plasma comprises the steps of:
   applying electric voltage to the piezoelectric element, and
   thereby forming the cold plasma for cleaning the surface of the heating element.
O. Method for cleaning according to example M, wherein the electric voltage has a peak to peak AC voltage in a range of 5-15 Vpp.
P. Method for cleaning according to example M, wherein the electric voltage causes a mechanical oscillation of the piezoelectric element with a frequency in a range of 10 kHz and 500 kHz. Method for cleaning according to one of example P, wherein the mechanical oscillation propagates along the piezoelectric element and creates an electric field with an electric potential in a range of 3 kV to 20 kV.
Q. Method for cleaning according to example Q, wherein the electric field results in ionization gas.
R. Method for cleaning according to example R, wherein the ionization gas forms the cold plasma for cleaning the heating element.
S. Method for cleaning according to example M, wherein for cleaning the surface of the heating element, the cold plasma breaks down organic molecules of organic residues on the surface of the heating element into lighter organic residuals and/or volatilizable organic molecules, wherein the lighter organic residuals oxidize to form carbon oxides and water vapour, and wherein the carbon oxides, the water vapour and/or the volatilizable organic molecules evaporate at room temperature from the heating element.
T. Method for cleaning according to example M, wherein the cold plasma is generated at atmospheric pressure.
U. Method for cleaning according to example M, wherein the cold plasma is generated at a temperature in a range of 17 to 75 degree Celsius.
V. A method for manufacturing an aerosol-generating device, the method comprises the steps of:
   providing a heating element for heating an aerosol-generating article to generate an aerosol,
   providing a cleaning unit comprising at least one piezoelectric element, the piezoelectric element being configured to generate cold plasma for cleaning the surface of the heating element, and
   arranging the cleaning unit to allow a cooperation with the heating element for cleaning the surface of the heating element.
W. Method for manufacturing according to example W, further comprising the step of providing a user-operable button on the aerosol-generating device configured to activate the cleaning unit.
X. Method for manufacturing according to example W, further comprising the step of providing a control unit configured to activate the cleaning unit at predetermined intervals.

Examples will now be further described with reference to the figures in which:

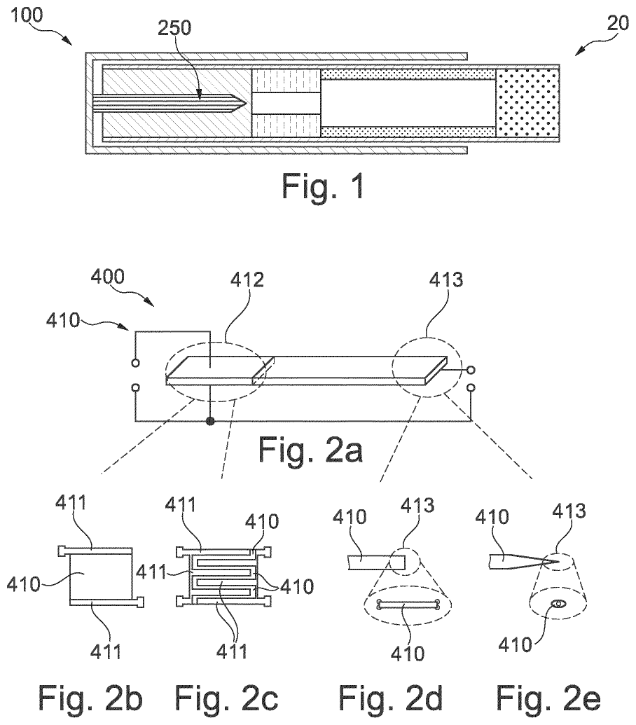

FIG. 1 shows schematically and exemplarily an embodiment of an aerosol-generating device according to the disclosure;

FIGS. 2a to 2e show schematically and exemplarily an embodiment of a piezoelectric element according to the disclosure;

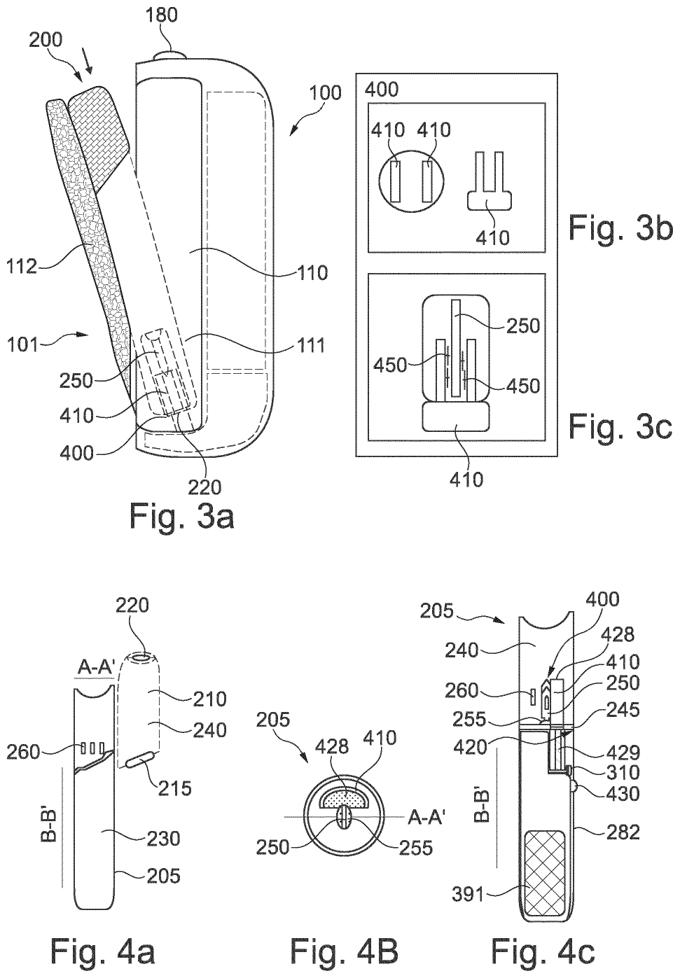

FIGS. 3a to 3c shows schematically and exemplarily an embodiment of an aerosol-generating device according to the disclosure;

FIGS. 4a to 4c shows schematically and exemplarily another embodiment of an aerosol-generating device according to the disclosure;

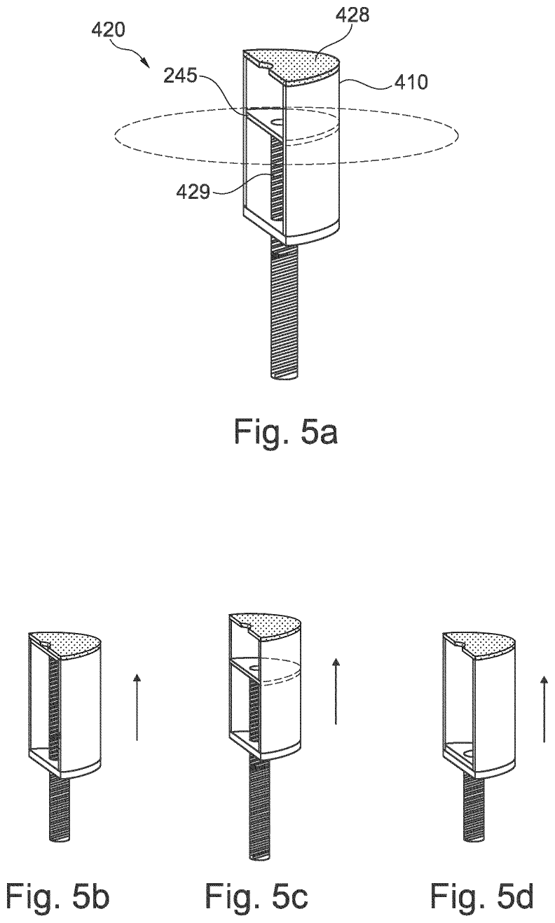

FIGS. 5a to 5d shows schematically and exemplarily an embodiment of a retraction cleaning arrangement according to the disclosure;

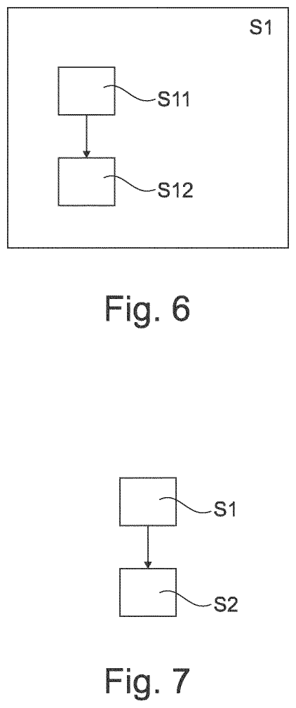

FIG. 6 shows schematically and exemplarily a method for cleaning a heating element of an aerosol-generating device according to the disclosure; and

FIG. 7 shows schematically and exemplarily a method for manufacturing an aerosol-generating device with a heating element to heat an aerosol-generating substrate and a cleaning unit to clean a surface of the heating element according to the disclosure.

FIG. 1 shows an aerosol-generating device 100 according to the disclosure, which interacts with an aerosol-forming substrate 20 to generate an aerosol. The aerosol-generating device 100 comprises a heating element 250. The heating element 250 heats an aerosol-generating article to generate an aerosol. The heating element 250 is here substantially blade-shaped. The heating element 250 has a length that in use extends along a longitudinal axis of the aerosol-forming substrate 20 engaged with the heating element 250, a width and a thickness. The width is greater than the thickness. The heating element 250 terminates in a point or spike for penetrating the aerosol-forming substrate 20. The heating element 250 comprises an electrically insulating substrate, which defines the shape of the heating element 250. The electrically insulating material may be, for example, alumina (Al₂O₃), stabilized zirconia (ZrO₂).

The aerosol-generating device 100 comprises the heating element 250 and a cleaning unit 400 (shown in FIGS. 2). The heating element 250 and the cleaning unit 400 are arranged within and integrated into the aerosol-generating device 100. The cleaning unit 400 is arranged close or next to the heating element 250 to cooperate with the heating element 250 for cleaning a surface of the heating element 250.

As shown in FIG. 2a, the cleaning unit 400 is a plasma cleaner for cleaning the heating element 250. The cleaning unit 400 comprises one or more piezoelectric element(s) 410. The piezoelectric element 410 is a cuboid with a longitudinal direction. It has a first end or region 412 and a second end or region 413 opposite to the first end 412 with respect to the longitudinal direction of the cuboid.

The piezoelectric element 410 generates cold plasma in a vicinity of the surface of the heating element 250. The cold plasma interacts with the surface of the heating element 250 for cleaning the surface to remove or reduce accumulated organic residues on the heating element 250.

In more detail: The piezoelectric element 410 is subjected at its first end 412 to an electric voltage, preferably with an input voltage of e.g. 5 to 15 Vpp. The piezoelectric element 410 reacts by generating mechanical oscillation. The mechanical oscillation preferably has a frequency in a range of 10 kHz and 500 kHz. The mechanical oscillation propagates to the second end 413 of the piezoelectric element 410. There, the mechanical oscillation creates an electric field. The electric field has a higher output power compared to the input power at the first end 412. Preferably, the electric field has an electric potential from e.g. 3 kVpp to 20 kVpp. The electric field leads to ionized gas in the spatial vicinity of the piezoelectric element 410.

The ionized gas forms cold plasma in the vicinity or proximity of the piezoelectric element 410 and thereby also in the vicinity of the surface of the heating element 250. In a vicinity means that the generated cold plasma touches the surface of the heating element 250. Cold plasma comprises ions and neutrally charged particles (molecule and atoms) at a low temperature (17 to 75 degree Celsius) and hotter electrons. The piezoelectric element 410 generates the cold plasma at atmospheric pressure, in ambient air and at an overall temperature in a range of 17 to 75 degree Celsius.

The cold plasma interacts with unwanted residues on the surface of the heating element 250 for cleaning them from the heating element 250. The unwanted residues were generated by the heating of the aerosol-forming substrate 20. They might be non-volatile organic residues and in particular carbon species that remain and accumulate on the heating element surface.

The cold plasma can break down heavy organic molecule residuals to light residuals. The light residuals may be volatilizable organic molecules. Also the heavy organic molecules may be volatilizable. The volatilizable organic molecules evaporate from the heating element surface leaving it in a cleaner state. The light organic residual chemical species on the heating element 250 can oxidize to form oxides and water vapour. As a result, the cold plasma cleans the heating element 250 by reducing, removing, liberating and/or eliminating the unwanted species on the surface of the heating element 250.

As shown in FIG. 2a, the piezoelectric element 410 is a cuboid with a longitudinal direction. It comprises the first end or region 412 and the second end or region 413 opposite to the first end 412 with respect to the longitudinal direction of the cuboid.

As shown in FIG. 2b, the cleaning unit 400 comprises two electrodes 411 and the first end 412 of the piezoelectric element 410 is arranged between these electrodes 411.

As shown in FIG. 2c, the cleaning unit 400 comprises a plurality of piezoelectric elements 410 and a plurality of electrodes 411. The plurality of electrodes 411 can be multiple co-fired electrodes 411. Respective first ends 412 of the plurality of piezoelectric elements 410 are arranged between adjacent electrodes 411 in a layered stack arrangement.

The cold plasma is formed when a predetermined electrical field strength on the surface of the piezoelectric element 410 is reached. Piezoelectric direct discharge from corners and edges of the piezoelectric element 410 occur as cold plasma in form of ionic wind jets. As shown in the following, the form of the ionic wind jets can be controlled using the different shapes of the piezoelectric element 410.

As shown in FIG. 2d, the second end 413 of the piezoelectric element 410 has, in a cross-section, a rectangular shape with four corners. At these corners, cold plasma is generated as multiple, here four, direct discharge ionic wind jets in an orthogonal plane relative to a front face of the piezoelectric element 410.

As shown in FIG. 2e, the second end 413 of the piezoelectric element 410 can have, in a cross-section, a sharp ending, protrusion or tip, which may generate at a single point a single ionic wind jet in an orthogonal plane relative to a tip of the piezoelectric element 410.

As shown in FIG. 3a, the aerosol-generating device 100 comprises a charging unit 101 for receiving charging power for a power unit (not shown). The power unit supplies power to the heating element 250 and to the cleaning unit 400. The power unit may be or comprise a (rechargeable) battery.

The charging unit 101 has a stick holder charging compartment 110 with a top end comprising an opening for inserting a stick or aerosol-generating article. The charging unit 101 has a bottom end opposite to the top end. In the embodiment shown in FIGS. 3a to 3c, the cleaning unit 400 is arranged inside the charging unit 101 and in particular at the bottom end of the charging unit 101.

The cleaning unit 400 is arranged at the bottom inside the stick holder charging compartment 110. The piezoelectric element 410 is arranged at the bottom of a stick holder cavity 111 in the charging unit 101. The stick holder cavity 111 accepts the stick or aerosol-forming substrate in a way such that the piezoelectric element 410 passes through a cap opening 220 of a stick holder 200. The piezoelectric element 410 is shown in FIG. 3b in a top view and in a side view.

As shown in FIG. 3c, the piezoelectric element 410 is close to the heating element 250. The piezoelectric element 410 gets charged to generate cold plasma 450 directly in incidence to the heating element 250. The generated cold plasma 450 allows volatilizing and oxidizing organic residues on the heating element 250.

The cleaning procedure requires the user to insert the stick holder 200 for holding the stick or aerosol-generating article inside the aerosol-generating device 100. The aerosol-generating device 100 receives the stick holder 200 in the stick holder charging compartment 110 of the charging unit 101 in a manner that the piezoelectric element 410 on the cleaning unit 400 enters into the stick holder 200 through the cap opening 220.

Once the stick holder 200 is in its position, a cavity door 112 of the aerosol-generating device 100 is closed by moving a hinge opening toward the charging compartment. On closing the cavity door 112, the user presses a cleaning activation button 180, which activates the cleaning of the heating element 250. On completion of the cleaning, the stick holder 200 can be removed from the aerosol-generating device 100 and would be ready for the next experience.

In the embodiment shown in FIGS. 4a to 4c, indication A-A′ and B-B′ are markers for top and dissection view of a stick holder 200. A cleaning unit 400 and a piezoelectric element 410 are arranged inside the stick holder 200. The piezoelectric element 410 is here in an arc shape. The piezoelectric element 410 is retractable using a retracting cleaning arrangement 420.

The operation is as follows: To initiate the cleaning, the user may press a retraction button 430, which activates the cleaning. The cleaning function starts with the movement of the retraction cleaning arrangement 420 vertically upward toward a heating element 250. Once the position of the piezoelectric element 410 is in-line with the heating element 250, the cleaning process starts. On completion of the cleaning process, the retraction mechanism 420 automatically moves downward and makes space available to receive new aerosol-generating articles into the stick holder 200.

FIGS. 4a to 4c and FIGS. 5a to 5d explain the retraction cleaning arrangement 420 in more detail. For activating the cleaning process, in FIG. 4a, the retraction button 430 is pressed, which activates a micro-motor 310. As shown in FIGS. 4b to 4d, the micro-motor 310 spins a threaded spindle 429 to move the piezoelectric element 410 upwards from a lower part 205 so to bring the piezoelectric element 410 closer to the heating element 250. Once the piezoelectric element 410 and the heating element 250 are aligned as desired, the cold plasma generation may be activated. The cold plasma generated, namely in the form of ionic wind jets, comes directly in contact with organic residues on the heating element 250. This interaction results in oxidization and evaporation of organic residues on the heating element 250 at room temperature.

When the cleaning process is complete, the micro-motor 310 lowers the retracting cleaning arrangement 420 below a separator 245 and a top cladding 428 on the piezoelectric element 410 comes in line with the separator 245 and seals the retracting cleaning arrangement 420. The micro-motor 310 progresses and stops the retraction mechanism automatically.

As shown in FIGS. 4a to 4c, the stick holder 200 comprises a removable cap 210 with a cap opening 220 on top, a stick holder housing 230, a cap housing 240, and a cap releasing button 215. The cap housing 240 comprises side openings 260, a rechargeable battery 391, electronics 282, a heating element assembly support 255. The cap 210 and the cap releasing button 215 is optional. The cap releasing button 215 can also be provided on the stick holder housing 230.

FIG. 6 shows a method for cleaning a heating element 250 of an aerosol-generating device 100. The method for cleaning a heating element 250 of an aerosol-generating device 100 comprises the step S1 of generating cold plasma by means of a piezoelectric element 410, wherein the cold plasma cleans a surface of the heating element 250.

The step S1 of generating cold plasma comprises the sub step S11 of applying electric voltage to a first region of the piezoelectric element 410 and the sub step S12 of thereby forming cold plasma in a vicinity of the surface of the heating element 250. The electric voltage causes a mechanical oscillation of the piezoelectric element 410. The mechanical oscillation propagates along the piezoelectric element 410, for example from the first region to the opposite, second region. At the second region, the mechanical oscillation creates an electric field. The electric field results in ionization gas. The ionization gas forms the cold plasma for cleaning the heating element 250. The cold plasma is generated at atmospheric pressure and at a temperature in a range of 17 to 75 degree Celsius.

The cold plasma breaks down organic molecules of organic residues on the surface of the heating element 250 into lighter and/or volatilizable organic molecules. The lighter organic residuals can oxidize to form oxides and water vapour. The oxides, the water vapour and/or the volatilizable organic molecules can evaporate at room temperature from the heating element 250.

FIG. 7 shows a method for manufacturing an aerosol-generating device 100 with a heating element 250 to heat an aerosol-generating substrate and a cleaning unit 400 to clean a surface of the heating element 250. The method for manufacturing an aerosol-generating device 100 comprises the following steps, not necessarily in this order:
S1. providing the heating element 250 for heating an aerosol-generating article to generate an aerosol and providing the cleaning unit 400 comprising at least one piezoelectric element 410, the piezoelectric element 410 being configured to generate cold plasma for cleaning the surface of the heating element 250, and
S2. arranging the cleaning unit 400 to allow a cooperation with the heating element 250 for cleaning the surface of the heating element 250.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±20% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed disclosure. Also, all ranges include the maximum and minimum points disclosed and include any intermediate ranges therein, which may or may not be specifically enumerated herein.

Although illustrative examples of the present disclosure have been described above, in part with reference to the accompanying drawings, it is to be understood that the disclosure is not limited to these examples. Variations to the disclosed examples can be understood and effected by those skilled in the art in practicing the disclosure, from a study of the drawings, the specification and the appended claims.

In the claims, any reference signs placed between parentheses shall not be construed as limiting the claim. The term “comprising” does not exclude the presence of elements or steps other than those listed in a claim. The word “a” or “an” preceding an elements does not exclude the presence of a plurality of such elements. The disclosure can be implemented by means of hardware comprising several distinct elements. In the device claim enumerating several means, several of these means can be embodied by one and the same item of hardware. The mere fact that certain measured are recited in mutually different dependent claims does not indicate that a combination of these measure cannot be used to advantage.

1.-15. (canceled)

16. An aerosol-generating device, comprising:
a heating element configured to heat an aerosol-generating article to generate an aerosol; and
a cleaning unit arranged to cooperate with the heating element and being configured to clean a surface of the heating element,
wherein the cleaning unit comprises at least one piezoelectric element, and
wherein the piezoelectric element is configured to generate cold plasma to clean the surface of the heating element.

17. The aerosol-generating device according to claim 16, wherein the piezoelectric element is further configured to generate the cold plasma at atmospheric pressure.

18. The aerosol-generating device according to claim 16, wherein the piezoelectric element is further configured to generate the cold plasma at a temperature in a range of 17 degrees Celsius to 75 degrees Celsius.

19. The aerosol-generating device according to claim 16,
wherein the piezoelectric element has a first end,
wherein the cleaning unit further comprises at least two electrodes, and
wherein the first end of the piezoelectric element is arranged between the at least two electrodes.

20. The aerosol-generating device according to claim 16,
wherein the piezoelectric element has a first end, and
wherein the piezoelectric element has a second end with a protrusion to generate the cold plasma as a point ionic wind jet in a substantially orthogonal plane relative to the protrusion.

21. The aerosol-generating device according to claim 16,
wherein the piezoelectric element has a first end, and
wherein the piezoelectric element has a second end with a rectangular shape with at least two corners at the second end to generate the cold plasma as direct discharge ionic wind jets in an orthogonal plane relative to a front line connecting the at least two corners.

22. The aerosol-generating device according to claim 16,
further comprising a charging unit configured to receive charging power for a power unit of the aerosol-generating device,
wherein the charging unit has a top end with an opening configured for insertion of the aerosol-generating article and a bottom end opposite to the top end, and
wherein the cleaning unit is arranged inside the charging unit and at a bottom end of the charging unit.

23. The aerosol-generating device according to claim 16,
further comprising a holding unit configured to receive the aerosol-generating article,
wherein the piezoelectric element is arranged inside the holding unit.

24. The aerosol-generating device according to claim 16,
wherein the cleaning unit further comprises a plurality of piezoelectric elements and a plurality of electrodes, and
wherein respective ends of the plurality of piezoelectric elements are arranged between adjacent electrodes in a layered stack arrangement.

25. The aerosol-generating device according to claim 16,
further comprising a power unit configured to supply power to the heating element and to the cleaning unit,
wherein the power unit is the only power supply of the aerosol-generating device.

26. A method for cleaning a heating element of an aerosol-generating device, the method comprising the step of:
generating cold plasma by means of a piezoelectric element, wherein the cold plasma cleans a surface of the heating element.

27. The method according to the claim 26, wherein the step of generating the cold plasma comprises the steps of:
applying electric voltage to the piezoelectric element, and
thereby forming the cold plasma for cleaning the surface of the heating element.

28. The method according to claim 27, wherein the electric voltage has a peak-to-peak AC voltage in a range of 5 Vpp to 15 Vpp.

29. The method according to claim 27, wherein the electric voltage causes a mechanical oscillation of the piezoelectric element with a frequency in a range of 10 kHz and 500 kHz.

30. A method for manufacturing an aerosol-generating device, the method comprising the steps of:
providing a heating element for heating an aerosol-generating article to generate an aerosol, and a cleaning unit comprising at least one piezoelectric element, the piezoelectric element being configured to generate cold plasma for cleaning a surface of the heating element; and
arranging the cleaning unit to allow a cooperation with the heating element for cleaning the surface of the heating element.
